(19) United States
(12) Patent Application Publication
(10) Pub. No.: US 2009/0248739 A1
(43) Pub. Date: Oct. 1, 2009

(54) System and Method to Support Runtime Model Extension in an Object Relational Mapping (ORM) System

(76) Inventors: Feng Cao, Beijing (CN); John Colgrave, Eastleigh (GB); Cassio Dos Santos, Boston, MA (US); Sheng Ping Liu, Beijing (CN); Robert Jeffrey Schloss, Briarcliff Manor, NY (US); Charles K. Shank, Uxbridge, MA (US); Chen Wang, Beijing (CN); Guo Tong Xie, Xi Er Qi (CN); Yang Yang, Beijing (CN)

Correspondence Address: IBM CORPORATION, T.J. WATSON RESEARCH CENTER, P.O. BOX 218, YORKTOWN HEIGHTS, NY, 10598, US

(21) Appl. No.: 12/411,518

(22) Filed: Mar. 26, 2009

(30) Foreign Application Priority Data
Mar. 28, 2008 (CN) 200810087972.3

(51) Int. Cl. G06F 17/30

(52) U.S. Cl. 707/103 R; 707/E17.055; 707/E17.045; 707/E17.005; 707/1

(57) ABSTRACT

A system and method to support runtime model extension in an Object Relational Mapping (ORM) System. The system includes a relational data storage subsystem for storing and retrieving objects in form of relational data, a tuple storage subsystem for storing and retrieving objects in form of tuple, and a dispatcher/assembler for storing and retrieving original part and extended part of the object respectively into/from the relational data storage subsystem and the tuple storage subsystem. Thus, model extension can be carried out dynamically in the runtime of the ORM system without modifying schema and migrating data in the relational database.

### CROSS REFERENCE TO RELATED APPLICATION

This application claims priority under 35 U.S.C. § 119 from Chinese Patent Application No. 200810087972.3 filed Mar. 28, 2008, the entire contents of which are incorporated herein by reference.

### BACKGROUND OF THE INVENTION

1. Field of the Invention

The invention relates to an object relational mapping (ORM) system. More particularly, the invention relates to a system and method to support runtime model extension in an ORM system.

2. Description of the Related Art

As object-oriented programming becomes a paradigm of enterprise software development, Object Relational Mapping (ORM) has been an increasingly popular technique and method for objects persistence. In object oriented (OO) programming, data management tasks are typically implemented by manipulating objects. However, relational databases such as DB2 and Oracle can only store and manipulate relational data which are organized within tables. Therefore, to save objects into a database, programmers must manually design the relational schema for objects and convert them into relational records. This may be easy for small object models. But the object-relational gap will quickly widen in applications involving large-scale object models.

Object Relational Mapping is used to map an object-oriented programming model to a relational database model managed by Oracle, DB2, Sybase and other relational database managers (RDBMS). From a programmer's perspective, an ORM system should look like a persistent object store. One can create objects and pass them to an ORM system. The ORM system will automatically process those objects in a database. Due to their advantages, there are many popular ORM products such as Websphere Metadata Server (XMeta), Apache OJB, Hibernate, and Oracle's Toplink.

### SUMMARY OF THE INVENTION

The present invention provides an object relational mapping system to support runtime model extension. The system includes a relational data storage subsystem for saving and retrieving objects in the form of relational data. The system further includes a tuple storage subsystem for saving and retrieving objects in form of tuples and a dispatcher/assembler for saving and retrieving objects into/from the relational data storage subsystem and the tuple storage subsystem respectively according to model information of the objects.

The present invention provides an object relational mapping method to support runtime model extension The method includes the step of saving or retrieving different components of an object in the form of relational data and in the form of tuple, respectively, according to model information of the object.

An advantage of storage in tuple is the possibility of extensions and modifications without requiring a redesign.

### BRIEF DESCRIPTION OF THE DRAWINGS

FIG. 1 shows an overall diagram of a conventional ORM system;

FIG. 2 illustrates an architecture of an extended ORM system according to an embodiment of the invention;

FIG. 3 illustrates a workflow chart when the extended ORM system saves objects; and

FIG. 4 illustrates a workflow chart when the extended ORM system retrieves objects.

### DETAILED DESCRIPTION OF THE PREFERRED EMBODIMENT

A system and method to support runtime extension to the ORM system is provided. This is achieved by providing a tuple storage subsystem. Here the tuple storage subsystem refers to the system which is designed to divide data into tuples in a uniform format for storage management.

The extension or modification to an object oriented model includes adding new attributes to existing classes, removing attributes from existing classes, adding new relationships between existing classes, removing relationships between existing classes, adding new classes, adding attributes to new classes, adding new relationships between new classes or existing classes, removing classes, and rename operations which can be implemented by add/remove operations.

To extend a deployed model in the runtime, a user needs to register the extension part of the model. When data needs to be saved, the system will automatically transform the data which are related to the extension part of the model into tuples and save them into the tuple storage subsystem. The data which is non-related to the extension part of the model will still be saved to the deployed model of the ORM system. In this way, the invention may support dynamic extension to the deployed model without changing the RDB schema deployed into the relational database and migrating the data in the relational database.

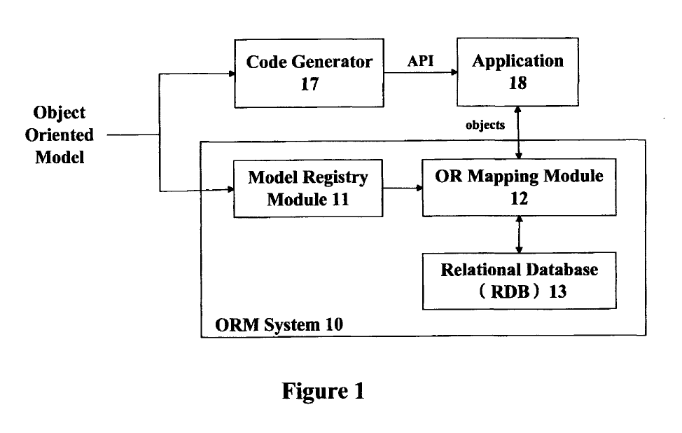

Fundamental configuration and operating principle of the ORM system will be introduced by reference to FIG. 1, which shows a structural diagram of a prior art ORM system 10. The ORM system 10 includes a model registry module 11, an object relational (OR) mapping module 12 and a relational database (RDB) 13. There is a code generator 17 and an application 18 outside the ORM system 10. The code generator 17 identifies classes and attributes in an object oriented model, generates an application programming interface (API) according to the identification and delivers the generated API to the application 18. The application 18 generates objects using the API delivered from the code generator 17. The operation of the code generator 17 and the application 18 is well known to those skilled in the relevant art and will not be further described.

To use the ORM system 10, a user needs to register an object oriented model with the ORM system 10. The system will leverage the OR mapping module 12 to generate an RDB schema for the registered model. The application 18 can then serialize objects which conform to the registered model into the ORM system 10. The OR mapping module 12 will automatically translate the objects into structural query language (SQL) statements. By using the ORM system 10, programmers can focus on business logic in an object oriented way and do not need to spend time on manually handling objects to RDB translations, which will greatly relieve the workload of programmers.

Typical steps of applying an ORM system will be exemplified:

(1) A designer designs an object oriented model for a particular application according to desired business logic. For example, in a flight ticketing system, a class “TicketOrder” may be declared with three attributes: the time “Time”, the name of customer “Name” and the flight number “Flight”. In practice, a class may have more attributes, e.g., price of ticket, name of airline, refund/endorsement, etc. If a model already exits, this step may be skipped.

(2) The data model created in the step (1) is input to the code generator 17 and the model registry module 11 of the ORM system 10, respectively. The data model is registered with the model registry module 11 and then supplied to the OR mapping module 12. The OR mapping module 12 generates, based on the data model, an RDB schema, which refers to, for example, a structure of tables in the relational database 13. On the other hand, the code generator 17 generates a corresponding API from the object oriented model.

(3) The RDB schema generated by the OR mapping module 12 in the step (2) is deployed in the relational database 13.

(4) The application 18 uses the generated API to create data objects. The OR mapping module 12 saves/loads the data objects into the relational database 13 by using the SQL language. In the above example, each time a client makes a request for a flight ticket, the application 18 creates a data object which contains three attribute values corresponding to the attributes “Time”, “Name” and “Flight”. This data object is saved into the relational database 13 as an entry of a table.

The above example is illustrated in the following table, in which an additional column “ID” may be automatically added by the OR mapping module 12 during creation of the RDB schema, or alternatively may be omitted.

### Class: TicketOrder

Attributes

| ID | Time | Name | Flight |
|---|---|---|---|
| 1 | 17:20 PM on May 11, 2007 | WANG Jun | CZ1246 |
| 2 | | | |
| . . . | | | |

ORM systems have many advantages over the conventional relational database. However, there are still some limitations on applications of an ORM system. Most ORM system implementations use a horizontal storage schema. In particular, each class will have a relevant table in the relational database, and each attribute of the class will have a relevant column in this table. Each instance of the class (an object) corresponds to a line of records in the table. No problem will rise when the model does not change. Unfortunately, data models do change from time to time, especially in a SOA (Service Oriented Architecture) environment. For example, as a result of changes to tax laws, airline companies need to append an item for fuel compensation tax in the TicketOrder table. In such a situation, the data model for the ticketing system only needs to append an attribute “FuelCompTax” to the class “TicketOrder”. However, to adapt this little change in the model, users need to (1) shut down the ORM system; (2) re-register a new model, generate a new RDB schema and conduct data migration from the old model to the new model in the relational database 13; and (3) upgrade the application 18 adapted to the old API version to one adapted to the new API.

Thus, current ORM systems can not support model upgrades in the runtime because once a model has been registered, the RDB schema is generated and deployed to the relational database. To upgrade a model, even to make a slight change, users need to shutdown the system, register a new model and migrate data from the old model. In the meanwhile, applications adapted to the old API also need to be upgraded to a new API because the old model API becomes obsolete after the upgrade. This is not economic in terms of time and costs and may sometimes intolerantly impact normal operation of a business system. A system and method which does not need to shutdown the ORM system when models are changed and which supports a dynamic runtime extension to the models deployed into the ORM system is desired.

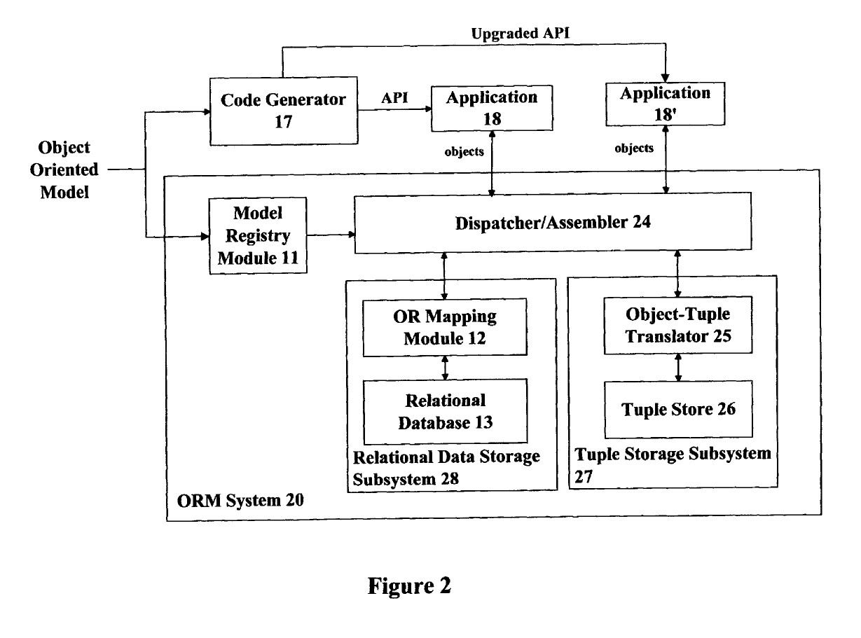

FIG. 2 illustrates an architecture of an extended ORM system 20 according to an embodiment of the invention. The extended ORM system 20 includes a model registry module 11, a dispatcher/assembler 24, a relational data storage subsystem 28 and a tuple storage subsystem 27. The relational data storage subsystem 28 includes a OR mapping module 12 and a relational database 13, which have the same functions as those of the components in FIG. 1. The tuple storage subsystem 27 includes an object-tuple translator 25 and a tuple store 26.

In the conventional ORM system, an object assigned as a class exists in the relational database as an entry (a line of records) of a table and includes attribute values corresponding to each of the attributes (each of the columns). For example, with reference to the above-mentioned class “TicketOrder”, the first line (1; 17:20 PM on May 11, 2007; WANG Jun; CZ1246) represents an object which has attribute values corresponding to four attributes, “ID”, “Time”, “Name” and “Flight”. Similarly, there are other objects in the other lines of the table.

A tuple is a finite sequence with n components (where n is an integer larger than 2). Tuple data is the data for describing the components of the tuple. A typical tuple is a triple with a data structure of subject-predict-object form. In the case of storage in the form of triple, each of the attributes of an object is represented as a triple. For an object A assigned as a class “TicketOrder”, the four attributes, “ID”, “Time”, “Name” and “Flight”, of the object A are represented as <A, ID, 1>, <A, Time, 17:20 PM on May 11, 2007>, <A, Name, WANG Jun> and <A, Flight, CZ1246), respectively, where the name of the object “A” is the subject, the attribute of the object is the predict, and the specific attribute value is the object.

Throughout the specification, a tuple storage system is the system which divides data into tuples in a uniform form for storage management. Then, a triple storage system is an architecture which divides data into triples of subject-predict-object structure for storage and retrieval. In a triple storage system, four triples representing the four attributes of the object A respectively will be saved sequentially.

Other objects may also be represented as a set of (four) triples and sequentially loaded to the triple storage system.

It is recognizable for those skilled in the relevant art that the tuple herein is not limited to the triple and the tuple storage system is also not limited to the triple storage system, and the other forms of tuples are applicable as desired. For example, a quaternary is applicable, which appends a new component in addition to the structure of the above triple, such as time of data creation, path of data creation and the like.

An advantage of storage in tuple is the possibility of extensions and modifications without requiring a redesign. For instance, suppose a new attribute is to be added to an object. The relational database needs to be re-designed and deployed with a new RDB schema which will append a column to the table. For a tuple storage system, it is only necessary to add a new tuple corresponding to the new attribute sequentially following original tuples of the object. Still, in the example of storage of the class “TicketOrder” in triple, if a new attribute of “FuelCompTax” is to be added, this may be done by appending a new triple <A, FuelCompTax, 50> to the triple storage system without changing original triples. This implies that the relational database is directed to storage on a column basis while tuple is directed to storage on a row basis. The tuple storage system has strong extendability but a lower storage efficiency than the relational database.

Currently there are many well-developed products for tuple storage, such as, the IBM's SOR, Webify Triple Store and Oracle's Oracle 10g.

Returning to FIG. 2, we will further describe the configuration and function of the extended ORM system 20. The model registry module 11 is a component for registering object models and declaring model extensions. It records two types of information: information registered for the first time and information on each extended model version. The model registry module 11 may be implemented by recording variations of each new model version relative to original model version. For example, if a model is upgraded from model_v1 to model_v2, the model registry module 11 will record a newly-added attribute1 (domain: Class1, range: string) and a deleted attribute attribute2 (domain: Class2, range: int), where “domain” represents the owner of the attribute (e.g., the owner of “attribute1” is the class “Class1”) and “range” represents the type or range of attribute values (e.g., the range of “attribute1” is character string and the range of “attribute2” is an integer). It is recognizable for those skilled in the relevant art that there are other possible methods of model registry, such as recording all the information on a new model, instead of its variation relative to the original one. However, any method that enables the ORM system 20 to distinguish which part of an object is related to the original model and which part of the object is related to the extended part is effective.

Next, the dispatcher/assembler 24 in FIG. 2 will be described. When saving/loading objects, the dispatcher/assembler 24 functions as a dispatcher, which identifies the model version to which the input object conforms, requests for relevant model registry information from the model registry module 11 according to the identified model version, and extracts data related to the original model and data related to the extended part from the input object according to the acquired model registry information. As an example, the dispatcher/assembler 24 identifies the model version of the object by deciding which version of API the object conforms to.

Then, the dispatcher/assembler 24 clones (or duplicates) the data related to the original model to a new object and passes this new object to the relational data storage subsystem 28 to be stored into the relational database 13 by the OR mapping module 12 in the conventional way. On the other hand, the dispatcher/assembler 24 passes the data related to the extended part to the tuple storage subsystem 27. In the tuple storage subsystem 27, the object-tuple translator 25 translates the data related to the extended part into a tuple form and then saves the data in form of tuple into the tuple store 26. A process of retrieving data from the ORM system 20 is reciprocal to the process of saving and the dispatcher/assembler 24 functions as an assembler. Detailed description of the process of retrieving will be given next.

The dispatcher/assembler 24 may be designed to include a plurality of apparatuses including identifying means for identifying the model version to which an object to be saved or retrieved conforms, requesting relevant model information from the model registry module 11 according to the identified model version, and distinguishing, in an object which conforms to an extended model, data related to the original model and data related to the extended part respectively according to the model information acquired from the model registry module 11.

The dispatcher/assembly 24 may also include dispatching means for dispatching the data related to the original model and the data related to the extended part respectively to the relational data storage subsystem 28 and the tuple storage subsystem 27 for storage when saving data.

The dispatcher/assembly 24 may also include assembling means for when retrieving data, assembling the data related to the original model and the data related to the extended part retrieved respectively from the relational data storage subsystem 28 and the tuple storage subsystem 27 into an object which conforms to a desired model version. It is recognizable to those skilled in the relevant art that those means can be implemented in hardware, software or combination thereof, not shown in the figures.

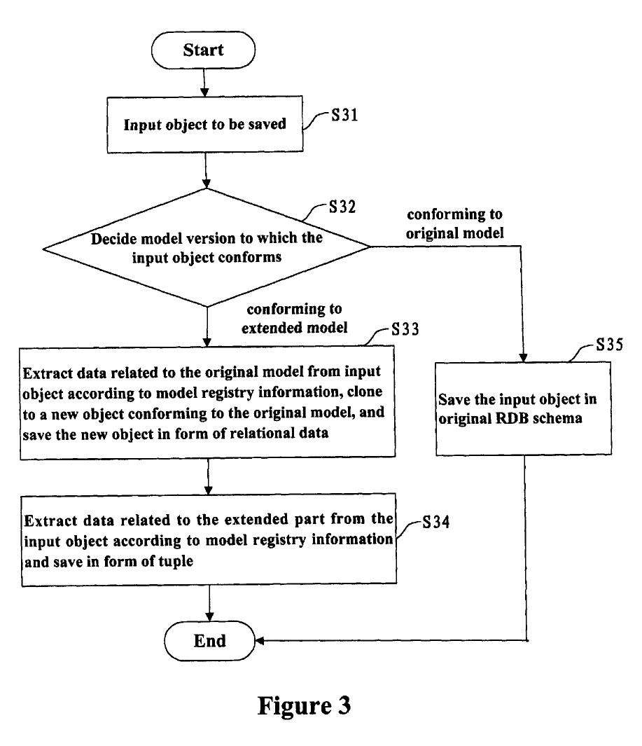

A process of adding a new attribute “FuelCompTax” to an object with three attributes, “Time”, “Name” and “Flight”, of class “TicketOrder” will be described with reference to FIGS. 2 and 3. FIG. 3 illustrates a workflow chart when the ORM system 20 saves objects.

It is supposed that the original object model contains three attributes, “Time”, “Name” and “Flight”, and has already been registered with the model registry module 11. At the same time, the code generator 17 generates an original API corresponding to the original model and the application 18 creates objects which conform to the original version of API and supplies them to the dispatcher/assembler 24. Additionally, the user designs an extended model with an added attribute “FuelCompTax” and registers it with the model registry module 11. Also, the code generator 17 generates an upgraded API corresponding to the extended model and supplies it to the application 18′. Note that the application 18 differs from the application 18′ only by adopting different APIs. They are separately shown in the drawings for clarity. Actually, the application 18′ is upgraded from the application 18 and not necessarily a separate module. The application 18′ uses the upgraded API to generate objects which conform to the upgraded API and supply these objects to the dispatcher/assembler 24.

Referring to FIG. 3, in step S31, an object to be saved is input to the ORM system 20. In step S32, the dispatcher/assembler 24 decides the model version to which the input object conforms. If the object conforms to the original model, then the dispatcher/assembler 24 directly passes the input object to the relational data storage subsystem 28 to be saved into the relational database 13 by the OR mapping module 12 in the conventional RDB schema, in step S35. If it is decided in step S32 that the object to be saved conforms to a certain extended model, then the dispatcher/assembler 24 requests model registry information of the object from the model registry module 11, extracts the data related to the original model from the input object according to the model registry information returned from the model registry module 11, clones or duplicates the data related to the original model to a new object conforming to the original model, and passes this new object to the relational data storage subsystem 28 to be saved into the relational database 13 by the OR mapping module 12 in the conventional RDB schema, as shown in step S33.

In step S34, the dispatcher/assembler 24 extracts the data related to the extended part from the input object according to the model registry information returned from the model registry module 11 and supplies the data related to the extended part to the tuple storage subsystem 27 to be translated into a tuple form by the object-tuple translator 25 and saved into the tuple store 26.

A process of saving objects is exemplified by reference to the above flight ticketing example. When an object to which a new attribute “FuelCompTax” is added is provided to the ORM system 20, the dispatcher/assembler 24 identifies and extracts the information related to three attributes, “Time”, “Name” and “Flight”, so as to be duplicated to a new object conforming to the original model. Because this new object conforms to the original model, it is of no problem to save it into the relational database 13 in the original RDB schema without re-designing and upgrading the relational database 13. On the other hand, the dispatcher/assembler 24 extracts the data related to the attribute “FuelCompTax” as an extension part from the input object. Then, the object-tuple translator 25 translates the data into a form of tuple, such as, a triple of <A, FuelCompTax, Value>, and saves it into the tuple store 26.

In another example, a modification to the model is a deletion of an attribute or relationship. In such a situation, in the S33 of FIG. 3, the duplicated new object has “null” attribute values for those deleted attributes and may still be saved into the relational database 13 in the original RDB schema.

It is apparent from the above description that the present invention partitions an extended object into two parts: one part conforming to the original model is saved into the relational database in the original RDB schema and the other part is translated into a form of tuple to be saved into the tuple storage subsystem. As such, model extension can be carried out dynamically in the runtime without modifying the schema in the relational database, thereby eliminating the necessity for shutting down the system, upgrading the RDB schema and migrating data, decreasing impact on the operation of the system and reducing costs and time.

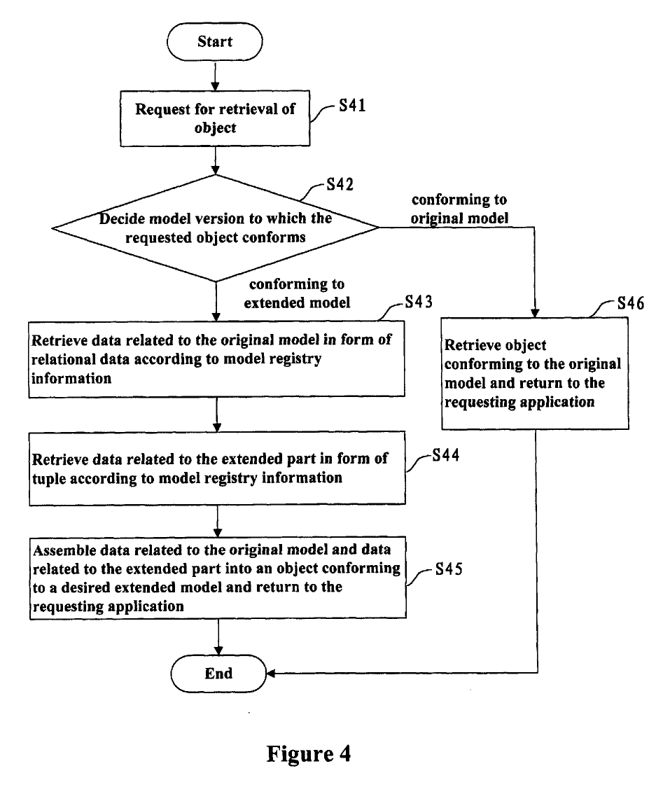

FIG. 4 illustrates a workflow chart when the extended ORM system 20 retrieves objects, as a reciprocal process to saving/loading objects. First, in step S41, the application 18 (18′) requests the ORM system 20 to retrieve an object. In step S42, the dispatcher/assembler 24 decides the model version to which the requested object conforms. If the requested object conforms to the original model, then in step S46, the dispatcher/assembler 24 directly requests this object from the relational data storage subsystem 28. Upon receipt of the request, the OR mapping module 12 issues a query to the relational database 13. If this object is found in the relational database 13, it is retrieved and returned to the requesting application 18 via the dispatcher/assembler 24. On the other hand, if it is decided in step S42 that the requested object conforms to a certain extended model version, then in step S43, the dispatcher/assembler 24 requests the data related to the original model from the relational data storage subsystem 28 according to the model registry information acquired from the model registry module 11. If the data is found in the relational database 13, it is retrieved by the OR mapping module 12 to be returned back to the dispatcher/assembler 24.

In step S44, the dispatcher/assembler 24 requests the data related to the extended part from the tuple storage subsystem 27 according to the model registry information acquired from the model registry module 11. If data related to the extended part is found in the tuple store 26, it is retrieved by the object-tuple translator 25 to be translated into data in the form of object and returned back to the dispatcher/assembler 24. Then, in step S45, the dispatcher/assembler 24 assembles the data returned respectively from the relational data storage subsystem 28 and the tuple storage subsystem 27 into a new object which conforms to the requested extended model version, and transmits this new object to the requesting application 18′.

Again, the previous example will be used to exemplify the process of retrieving objects. When a request for an object containing the attribute “FuelCompTax” is received, the dispatcher/assembler 24 identifies that the object conforms to an extended model and acquires relevant model registry information from the model registry module 11. Then, the dispatcher/assembler 24 retrieves the data portion related to the original model, which contains three attributes, “Time”, “Name” and “Flight”, from the relational data storage subsystem 28 according to the model registry information.

The dispatcher/assembler 24 also retrieves the tuple containing the attribute “FuelCompTax” as an extension part from the tuple storage subsystem 27, such as a triple of <A, FuelCompTax, Value>, and translates it into a form of object. Finally, the dispatcher/assembler 24 assembles the data portion related to the original model and the data portion containing the attribute as an extension part into an object containing all of the four attributes, which conforms to the model registered already with the model registry module 11.

The diagrams and flowcharts illustrate architectures, functions and operation of some embodiments of the systems and methods according to the invention. Each block in the diagrams or flowcharts may be a module, means, a device, a subsystem, code segment or part of code which incorporates one or more executable instructions for performing specified logic. It is also appreciated that the steps shown in FIGS. 3 and 4 are illustrative and may be added, deleted or modified. The sequence in which the steps are performed may also be changed. The steps shown to be performed sequentially may be carried out simultaneously or even in a reverse order, as appreciated by those skilled in the art.

The invention can be implemented in hardware, software or combination thereof.

Further, the invention may be embodied in a computer program product which may be accessed from computer usable medium or computer readable medium carrying program codes for use by or with a computer or an instruction executing system. For the present application, computer usable medium or computer readable medium may be any devices which contain, store, convey, transmit or transport programs for use by or with a computer or any instruction executing system, apparatus or device.

The medium may be an electric, magnetic, optical, electromagnetic, infrared or semiconductor system (or device or apparatus) or transmission medium. Examples of the computer readable medium include semiconductor or solid-state memory, magnetic tape, removable disk and optical disk. Existing examples of optical disk includes Compact Disk-Read Only Memory (CD-ROM), Compact Disk-Read/Write (CD-R/W) and DVD.

A data processing system adapted to store and/or execute program codes includes at least a processor coupled directly or indirectly to memory units via a system bus. Memory units may include local memories for use in execution of program codes, mass storage and cache memory which provides temporary storage for at least some of the program codes to reduce times to retrieve codes from the mass storage during execution.

The input/output or I/O devices (including but not limited to keyboard, display, pointing devices, etc.) may be coupled to the system directly or through an intervening I/O controller.

A network adaptor may also be coupled to the system to enable the data processing system to be coupled to other data processing systems or remote storage devices through intervening private or public networks. Modem, cable modem and Ethernet card are examples of currently available types of network adaptors.

Although the particular embodiments of the invention are described above with reference to the drawings, the description is only illustrative but not limiting in any sense. A person of ordinary skill in the art with the knowledge of the present invention can make various modification and variation to the above-mentioned embodiments without departing from the true spirit of the invention.

According to one aspect of the invention, an object relational mapping system to support runtime model extension is provided. The system includes a relational data storage subsystem for saving and retrieving objects in the form of relational data and is characterized by further including a tuple storage subsystem for saving and retrieving objects in the form of tuples and a dispatcher/assembler for saving into and retrieving objects from the relational data storage subsystem and the tuple storage subsystem according to model information of the objects.

The above system of the invention may further include a model registry module for registering the model information of the objects and providing the registered model information to the dispatcher/assembler responsive to a request from the dispatcher/assembler, wherein the models of the objects include an original model and at least an extended model formed upon extension to the original model. The objects conforming to the extended model include two components: data that is related to the original model and data that is related to the extended part.

In the above system, the relational data storage subsystem may include a relational database for storing the objects and an object relational mapping module coupled between the dispatcher/assembler and the relational database for saving and retrieving the objects into/from the relational database. The tuple storage subsystem may include a tuple store for storing data in the form of tuple and an object-tuple translator coupled between the dispatcher/assembler and the tuple store for translating component data of the objects into data in the form of tuple. The object-tuple translator could then save the data into the tuple store, or retrieve the data in the form of tuple from the tuple store and then translate it into the component data of the objects.

In the above system, the dispatcher/assembler may include identifying means for identifying whether an object to be saved or retrieved conforms to an original model or an extended model formed upon extension to the original model; request relevant model information from the model registry module and distinguish, in the object, data related to the original model and data related to the extended part conforming to the extended model according to the model information acquired from the model registry module.

The dispatcher/assembler may also include dispatching means for storage of data; may dispatch the data related to the original model and the data related to the extended part to the relational data storage subsystem and the tuple storage subsystem for storage; include assembling means for data retrieval; and assemble the data related to the original model and the data related to the extended part retrieved from the relational data storage subsystem and the tuple storage subsystem into an object conforming to a desired model.

In the above aspect of the invention, the dispatcher/assembler is associated with an application outside the system, and the application instructs the dispatcher/assembler to save or retrieve objects. A code generator outside the system generates different versions of API according to different object models and supplies them to the application, and the identifying means identifies the model to which the object conforms by identifying the version of API with which the object is created.

According to another aspect of the invention, an object relational mapping method to support runtime model extension is also provided. The method includes: saving or retrieving different components of an object in the form of relational data and in the form of tuple, respectively, according to model information of the object.

The above method of the invention may further include registering model information of objects. The models of objects include an original model and at least an extended model formed upon extension to the original model.

In the above method of the invention, the step of saving or retrieving an object includes identifying whether the requested object conforms to an original model or an extended model formed upon extension to the original model upon a request for saving or retrieving the object. If the requested object conforms to the original model, the object is saved or retrieved in the form of relational data. If the requested object conforms to the extended model, then the step distinguishes, in the object, data related to the original model and data related to the extended part according to the registered model information, saves or retrieves the data related to the original model in form of relational data, and saves or retrieves the data related to the extended part in the form of tuple.

In the above method, in a situation requesting retrieval of the object, if the requested object conforms to the extended model, the data related to the original model in the form of relational data and the data related to the extended part in the form of tuple is assembled into an object conforming to a desired model.

In the above system, the model to which the object conforms may be identified by identifying the version of the API with which the requested object is generated.

It is apparent from the above description of the invention that the invention partitions an extended object into two parts, one which conforms to the original model and is saved in the original RDB schema and the other which is translated into a form of tuple for storage. Thus, extension to models may be performed dynamically in the runtime without modifying the RDB schema of the relational database, thereby eliminating the necessity for shutting down the system, upgrading the RDB schema and migrating data, decreasing impact on the operation of the system and reducing costs.

We claim:

1. An object relational mapping system to support runtime model extension having a relational data storage subsystem for saving and retrieving objects in the form of relational data, said system comprising:
a tuple storage subsystem for saving and retrieving objects in form of tuples; and
a dispatcher/assembler for saving and retrieving objects into/from the relational data storage subsystem and the tuple storage subsystem respectively according to model information of the objects.

2. The object relational mapping system of claim 1, further comprising:
a model registry module for registering the model information of the objects and providing the registered model information to the dispatcher/assembler responsive to a request from the dispatcher/assembler.

3. The object relational mapping system of claim 1, wherein the relational data storage subsystem comprises:
a relational database for storing the objects; and
an object relational mapping module coupled between the dispatcher/assembler and the relational database, for saving and retrieving the objects into/from the relational database.

4. The object relational mapping system of claim 1, wherein the tuple storage subsystem comprises:
a tuple store for storing data in form of tuple; and
an object-tuple translator coupled between the dispatcher/assembler and the tuple store, for translating component data of the objects into data in the form of tuple and then saving the data into the tuple store, or retrieving the data in the form of tuple from the tuple store and then translating it into the component data of the objects.

5. The object relational mapping system of claim 2, wherein the dispatcher/assembler comprises:
identifying means for identifying whether an object to be saved or retrieved conforms to an original model or an extended model formed upon extension to the original model, requesting relevant model information from the model registry module, and distinguishing, in the object, data related to the original model and data related to the extended part conforming to the extended model according to the model information acquired from the model registry module;
dispatching means for dispatching the data related to the original model and the data related to the extended part respectively to the relational data storage subsystem and the tuple storage subsystem for storage during data storage; and
assembling means for assembling the data related to the original model and the data related to the extended part retrieved respectively from the relational data storage subsystem and the tuple storage subsystem into an object conforming to a desired model during data retrieval.

6. The object relational mapping system of claim 5, wherein the dispatcher/assembler is associated with an application outside the system, and the application instructs the dispatcher/assembler to save or retrieve objects.

7. The object relational mapping system of claim 6, wherein a code generator outside the system generates different versions of API according to different object models and supplies them to the application, and the identifying means identifies the model to which the object conforms by identifying the version of API with which the object is created.

8. The object relational mapping system of claim 2, wherein the model extension comprises at least one of:
adding one or more new attributes to an existing class;
deleting one or more attributes from an existing class;
adding one or more new relationships between existing classes;
deleting the relationships between existing classes;
adding a new class;
deleting a class; and
renaming operation.

9. The object relational mapping system of claim 8, wherein adding a new class comprises at least one of:
adding one or more attributes to the new class; and
adding new relationships between the new class and existing classes.

10. An object relational mapping method to support runtime model extension, comprising:
saving or retrieving different components of an object in the form of relational data and in the form of tuple, respectively, according to model information of the object.

11. The object relational mapping method of claim 10, further comprising registering the model information of the object.

12. The object relational mapping method of claim 11, wherein the step of saving or retrieving comprises:
upon a request for saving or retrieving the object, identifying whether the requested object conforms to an original model or an extended model formed upon extension to the original model;
if the requested object conforms to the original model, the object is saved or retrieved in form of relational data;
if the requested object conforms to the extended model, then
distinguishing, in the object, data related to the original model and data related to the extended part according to the registered model information,
saving or retrieving the data related to the original model in form of relational data, and
saving or retrieving the data related to the extended part in form of tuple.

13. The object relational mapping method of claim 12, wherein in a situation requesting retrieval of the object, if the requested object conforms to the extended model, the data related to the original model in the form of relational data and the data related to the extended part in form of tuple is assembled into an object conforming to a desired model.

14. The object relational mapping method of claim 13, wherein the step of identifying whether the requested object conforms to the original model or the extended model comprises identifying the model to which the object conforms by identifying the version of API with which the object is created.

15. The object relational mapping method of claim 11, wherein the model extension comprises at least one of:
adding one or more new attributes to an existing class;
deleting one or more attributes from an existing class;
adding one or more new relationships between existing classes;
deleting the relationships between existing classes;
adding a new class;
deleting a class; and
renaming operation.

16. The object relational mapping method of claim 15, wherein adding a new class comprises at least one of:
adding one or more attributes to the new class; and
adding new relationships between the new class and existing classes.

17. An object relational mapping system to support runtime model extension, said system comprising:
a relational data storage subsystem for saving and retrieving objects in the form of relational data;
a tuple storage subsystem for saving and retrieving objects in form of tuples; and
a dispatcher/assembler for saving and retrieving objects into/from the relational data storage subsystem and the tuple storage subsystem respectively according to model information of the objects.
